(19) United States
(12) Patent Application Publication
(10) Pub. No.: US 2016/0350849 A1
(43) Pub. Date: Dec. 1, 2016

(54) COMPUTERIZED METHOD AND SYSTEM OF CREDIT APPLICATION AND ISSUANCE THEREOF

(71) Applicant: MASTERCARD ASIA/PACIFIC PTE LTD., Singapore (SG)

(72) Inventor: Kieran LYNCH, Randwick (AU)

(73) Assignee: MASTERCARD ASIA/PACIFIC PTE LTD., Singapore (SG)

(21) Appl. No.: 15/158,943

(22) Filed: May 19, 2016

(30) Foreign Application Priority Data
May 27, 2015 (SG) 10201504183Y

(51) Int. Cl. G06Q 40/02; G06Q 20/24

(52) U.S. Cl. CPC G06Q 40/025; G06Q 20/24

(57) ABSTRACT

A computerized method of issuing credit to an applicant has steps of: (a) receiving credit application request from the applicant, said credit application request being transmitted electronically via a mobile data input device of the applicant; (b) sending an electronic query to the applicant requesting a response including application data required from the applicant; (c) electronically receiving the application data via the data input device, said application data containing information indicative of an identity of the applicant; (d) electronically obtaining a verified identity of the applicant using the application data; (e) electronically determining a credit limit using the verified identity of the applicant; and (f) electronically transmitting a payment token to the data input device of the applicant, wherein said payment token is a system of payment capable of making a payment up to the determined credit limit. A computer system for carrying out the above method is also provided.

### FIELD OF INVENTION

The present invention relates to a computerized method and system for credit application and issuance.

### BACKGROUND

Currently, the process of applying for and obtaining credit, such as a credit card or cash loan, is complicated and lengthy. For example, for an application for a credit card, an applicant is required to manually fill in a credit card application form with his personal particulars and other information as required by a lending institution, such as banks. After that, the applicant submits the application form together with supporting documents to the banks for processing the credit card application.

Typically, after bank receives the application, a credit card officer enters the applicant's information into the bank's system. Necessary steps are then performed to complete the application, such as reviewing the application and supporting documents, verifying the identity of the applicant and checking a credit history of the applicant with a credit bureau. For example, an underwriting group may be required to use information obtained to assess the eligibility of the applicant for the credit card, before making a decision to approve or reject the application. After the decision has been made and verified, the bank arranges for a credit card to be mailed to the applicant's address. In most cases, as a security measure, activation of the credit card is also required before any payment can be made via the card. The whole process typically takes about two weeks for a successful applicant to be able to use his card from the time he starts the application.

An improved system and method for credit application and issuance is therefore desired given the inconvenience of the current method.

### SUMMARY OF THE INVENTION

In general terms, the present invention proposes a computerized, automated system and method for credit application which allows an applicant to apply for and gain access (if the application is successful) to the credit in a much more efficient manner.

According to a first aspect of the invention, there is provided a computerized method of issuing credit to an applicant, comprising steps of:

(a) receiving a credit application request from the applicant, said credit application request being transmitted electronically via a mobile data input device of the applicant (such as a mobile phone);

(b) sending an electronic query to the applicant requesting a response including application data required from the applicant;

(c) electronically receiving the application data via the data input device, said application data containing information indicative of an identity of the applicant;

(d) electronically obtaining a verified identity of the applicant using the application data;

(e) electronically determining a credit limit using the verified identity of the applicant; and

(f) electronically transmitting a payment token to the data input device of the applicant, wherein said payment token is a system of payment capable of making a payment up to the determined credit limit.

This enables a credit application to be processed in an efficient manner without requiring manual processing of the application at each step. It allows an eligible applicant not only to obtain credit very fast but also to be able to use the credit almost immediately once the application has been approved by electronically transmitting the payment token to the applicant. Transmitting the token to the specific data input device of the applicant also enhances the security of the method.

Notably, embodiments of the present invention provide an automated electronic system and method for obtaining credit in a fast, secure and consistent manner since they require little (if any) human intervention. The system is advantageously configured for direct communication with the user via his/her mobile data input device as well communication with an electronic identity verification system and electronic credit check system. Embodiments of the invention effectively provide an automated system for apply for credit, assessing the credit application (including verifying the identity of the applicant and determining a suitable credit limit) and, if successful, issuing the credit via a virtual payment token.

The term “payment token” refers to an identifier (such as a card number, or a QR code etc.) that the data input device uses in place of any card number printed on a plastic or other physical payment card. The identifier is associated with the line of credit offered to the applicant.

In one embodiment, the application data comprises information required by a lending institution which issues the credit to the applicant.

In one embodiment, the application data comprises information input by the applicant via the data input device. In another embodiment, the data input device may have relevant data stored (including the application data required) and is configured to allow the application data to be accessed and electronically transmitted to a credit application system without requiring any manual input by the applicant.

In one embodiment, the application data comprises information associated with the data input device of the applicant, for example, if such information allows the identity of the applicant to be uniquely identified.

In one embodiment, the application data comprises a unique identifier of the data input device.

In one embodiment, the application data comprises credentials of the applicant for a payment system at which the applicant has previously registered, such as the MasterPass™ system, which permits a user to register one or more credit or debit cards in a “digital wallet”. This could allow the applicant to be identified more efficiently, with fewer information fields.

In one embodiment, step (d) comprises verifying the identity of the applicant using the application data and an electronic verification system containing a database storing personal particulars of the applicant.

In one embodiment, step (e) comprises performing a credit check using the verified identity of the applicant to obtain a credit score, and determining the credit limit using the credit score.

In one embodiment, step (e) further comprises updating the credit limit using the application data received via the data input device.

In one embodiment, step (f) further comprises creating a link between the payment token and the data input device such that the payment token is capable of making the payment upon an authorization by the data input device. In other words, the payment token is “locked” to a specific data input device. In one embodiment, the payment token is capable of making the payment upon an authorization by a component (e.g. a SIM card or a unique identifier) of the data input device. This will prevent any unauthorized transaction if the token is compromised.

According to a second aspect, there is provided a computer system having a processor and a data storage device storing program instructions, the program instructions being operative upon being performed by the processor to cause the processor to perform a method of issuing credit to an applicant comprising steps of:

(a) receiving a credit application request from the applicant, said credit application request being transmitted electronically via a mobile data input device of the applicant;

(b) sending an electronic query to the applicant requesting a response including application data required from the applicant;

(c) electronically receiving the application data via the data input device, said application data containing information indicative of an identity of the applicant;

(d) electronically obtaining a verified identity of the applicant using the application data;

(e) electronically determining a credit limit using the verified identity of the applicant; and

(f) electronically transmitting a payment token to the data input device of the applicant, wherein said payment token is a system of payment capable of making a payment up to the determined credit limit.

According to a third aspect, there is provided a tangible data storage device, readable by a computer system and containing program instructions operable by a processor of the computer system to cause the processor to perform a method of issuing credit to an applicant comprising steps of:

(a) receiving a credit application request from the applicant, said credit application request being transmitted electronically via a mobile data input device of the applicant;

(b) sending an electronic query to the applicant requesting a response including application data required from the applicant;

(c) electronically receiving the application data via the data input device, said application data containing information indicative of an identity of the applicant;

(d) electronically obtaining a verified identity of the applicant using the application data;

(e) electronically determining a credit limit using the verified identity of the applicant; and

(f) electronically transmitting a payment token to the data input device of the applicant, wherein said payment token is a system of payment capable of making a payment up to the determined credit limit.

In a further aspect, there is provided a mobile data input device having a processor and a data storage device storing program instructions, the program instructions being operative upon being performed by the processor to cause the processor to perform a method of credit application comprising steps of:

(a) electronically transmitting a credit application request to a credit application system;

(b) receiving an electronic query requesting a response including application data required;

(c) electronically transmitting the application data to the credit application system for verification of an identity of the applicant, said application data containing information indicative of an identity of the applicant; and

(d) electronically receiving a payment token, wherein said payment token is a system of payment capable of making a payment up to a credit limit; wherein the credit limit is electronically determined using a verified identity of the applicant.

The term “credit” refers a fund offered by a financial institution or other lender to a debtor to use and which must be repaid within an agreed amount of time. For example, credit includes, but is not limited to, the credit offered in relation to credit cards and cash loans. The latter is relevant to a prepaid product.

Accordingly, the term “credit limit” refers to the maximum amount of credit that a financial institution or other lender will extend to a debtor for a particular line of credit.

### BRIEF DESCRIPTION OF THE DRAWINGS

Embodiments of the invention will now be described for the sake of example only, with reference to the following drawings in which:

FIG. 1 is a block diagram of an electronic credit application system according to an embodiment;

FIG. 2 is a flow diagram of a computerized method according to an embodiment;

FIG. 3 is a flow diagram of a computerized method according to another embodiment; and

FIG. 4 is a flow diagram of a computerized method according to a further embodiment.

### DETAILED DESCRIPTION

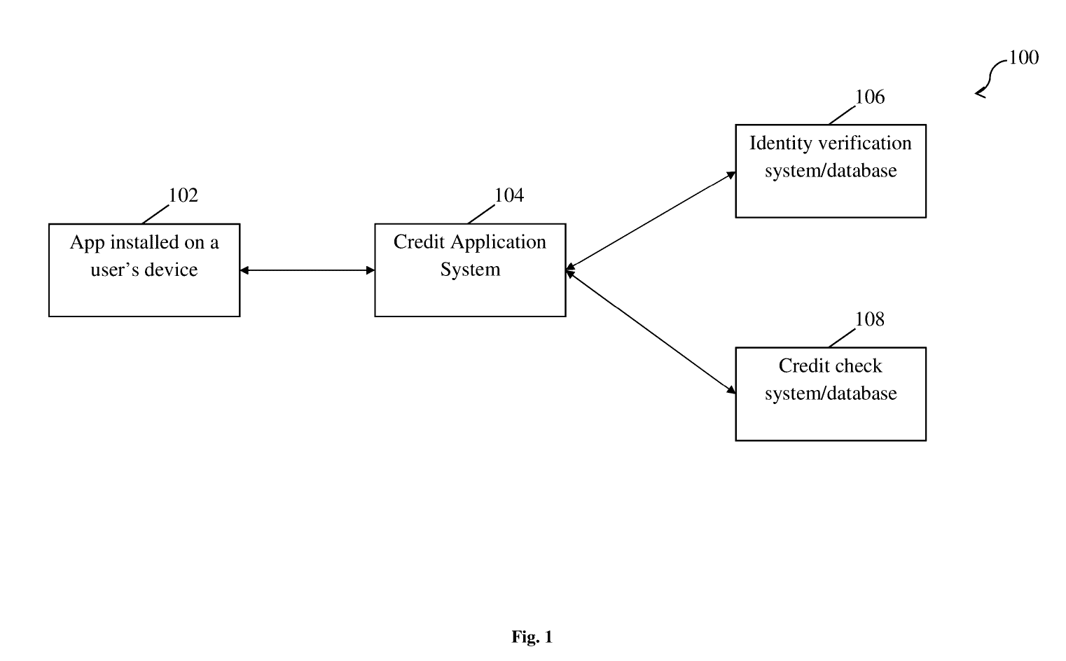

Referring to FIG. 1, an electronic credit application system 104 is made in communication with a software application 102 operable to run on a data input device of a user (typically an applicant or potential applicant of a credit service). The credit application system 104 is configured to receive data from the data input device of the applicant electronically via a wired or wireless communication network.

The credit application system 104 may be a computer system suitable for implementing one or more embodiments disclosed herein. The computer system typically includes a processor (which may be referred to as a central processor unit or CPU) that is in communication with memory devices or data storage devices such as, read only memory (ROM), random access memory (RAM), hard disk, input/output (I/O) devices, and network connectivity devices. The processor may be implemented as one or more CPU chips. It is understood that by programming and/or loading executable instructions onto the computer system, at least one of the CPU, the RAM, and the ROM are changed, transforming the computer system in part into a particular machine or apparatus having the novel functionality taught by the present disclosure.

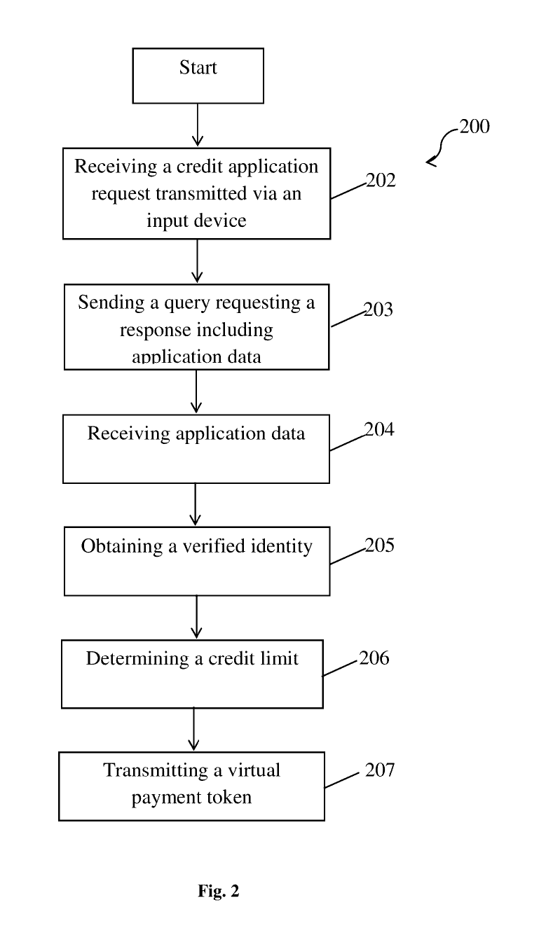

FIG. 2 shows an exemplary method 200 carried out by the credit application system 104 according to an embodiment. At step 202, the credit application system 104 receives an electronic credit application request from the software application 102 run on the data input device of the applicant. The data input device may be a mobile device such as a mobile phone, a wireless handset, a pager, a personal digital assistant (PDA), a gaming device, a media player, a tablet, a wearable computer, a headset computer, or the like. The data input device transmits electronically the credit application request to the credit application system 104, for example, in response to an applicant's command.

Upon the electronic request being received by the credit application system 104, the credit application system 104 processes the request and sends an electronic query to the applicant's data input device 203 requesting a response including application data from the applicant. For example, once the query has been received by the applicant's data input device, the data input device may be configured to download or fetch an electronic application form via a designated server.

The application form contains information fields to be filled by the applicant. In one embodiment, the information fields may comprise information required by a lending institution which issues the credit to the applicant. In one example, the application data contains at least one information field which is associated with the identity of the applicant, and allows the identity of the applicant to be uniquely identified by using information in a single or a combination of two or more fields. For example, the information fields may comprise one or more of the following: name, date of birth, an ID number, a driving license number, residential or professional addresses, personal or professional telephone numbers, employment information, income information, etc. The applicant may be required to electronically fill up selected fields of the application form.

In another embodiment, the applicant may choose to use MasterPass™ credentials in place of some or all of the information fields required for a faster completion of the application data. The information fields may be filled by inputting relevant information by the applicant manually via the data input device, or using information stored in the data input device.

In a particular example, the applicant may use biometric measures (which relates to physical characteristics of a person, such as fingerprints, eyes, hands) to fulfil the application data required. In another example, the application data required may be a unique identifier associated with the data input device, such as the IMEI number of a mobile phone or the SIM card associated with the phone.

After the credit application system electronically receives the application data via the data input device (step 204), the credit application system 104 electronically obtains a verified identity of the applicant. In one embodiment, the credit application system 104 is configured to send a verification request to an external electronic identity verification system 106 via a communication network to verify the identity of the applicant using the application data. For example, the identity of the applicant is verified using the application data provided via the data input device and a database storing personal particulars of the applicant.

Once the identity has been successfully verified, a credit check system 108 is used to electronically determine a credit limit using the verified identity of the applicant at step 206. In one example, a credit record is obtained for that particular applicant via the credit check system 108. The credit record may be in the form of a credit score, a credit history and/or a credit report. In one example, a credit limit may be determined using the results of the credit check. For example, the credit check system 108 may contain data associated with an existing credit limit with respect to a particular line of credit the applicant is currently holding, or was previously holding. In one embodiment, a default credit limit is given for each of the applicants having a credit record which meets a pre-determined criterion. The default credit limit may be determined based on the existing credit limit of the applicant.

In one embodiment, an enhanced credit assessment process may be performed for selected applicants, for example, for those who hold a superior credit record or for those who have indicated (e.g. in the application data) a preference for an updated credit limit to be assessed using the application data submitted, such as the updated employment or income information. If an applicant fails to pass the credit check or the enhanced credit assessment process, the credit application procedure will then end. The applicant may be notified of the outcome of the credit application.

In some embodiments, the credit application system 104, which is implemented as a computer system having the processor and data storage device as described above, may have the identity verification database 106 and/or credit check system 108 stored on the data storage device of the computer system.

At step 207, the credit application system 104 is configured to issue credit to a successful applicant by electronically transmitting a payment token to the data input device of the applicant. The payment token may be in a form of a QR code, a barcode or any other identifier (such as a credit card number) associated with the line of credit offered to the applicant. The virtual payment token is capable of making a payment (including cash withdrawals) up to the determined credit limit. In one embodiment, the provision of the token is made via the MasterCard Digital Enhancement Services (MDES) platform. For enhanced security, a link can be optionally created between the payment token and the data input device such that the payment token is “locked” to a specific device. In one embodiment, the payment token is capable of making the payment upon an authorization by a component (e.g. the SIM card) of the data input device.

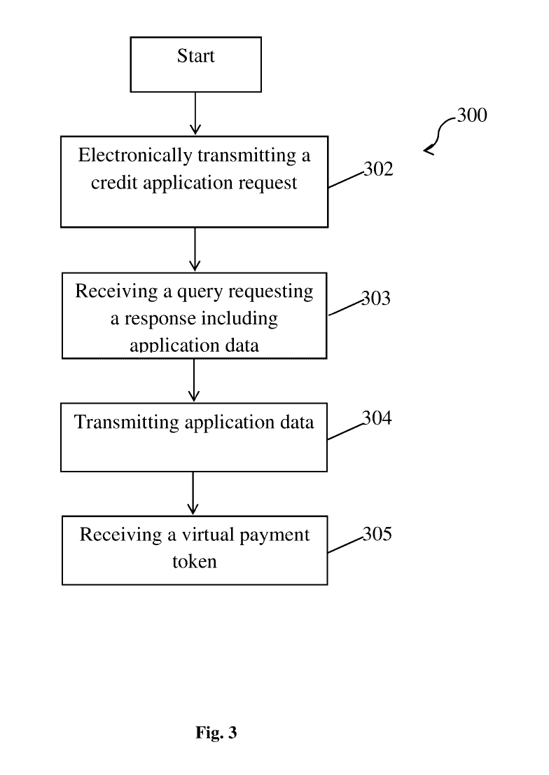

FIG. 3 shows an exemplary method 300 which can be carried out by a user's data input device carrying the software application 102 for making a credit application in accordance with one embodiment. At step 302, the software application is configured to cause the processor of the data input device of the applicant to electronically transmit a credit application request in response to the applicant's command, for example, via a user-interface of the data input device. At step 303, the data input device receives an electronic query requesting a response including application data from the applicant. This may include receiving and displaying an application form containing information fields required from the applicant for the purpose of credit application. In one embodiment, the user then manually inputs the data required into some or all of the information fields shown in the electronic application form and submits the application data. Optionally, some or all of the information fields may be completed automatically by the data input device based on data stored on the data input device. The data input device is configured to electronically transmit the application data (step 304) to the credit application system and is configured to electronically receive a payment token upon approval of the application at step 305.

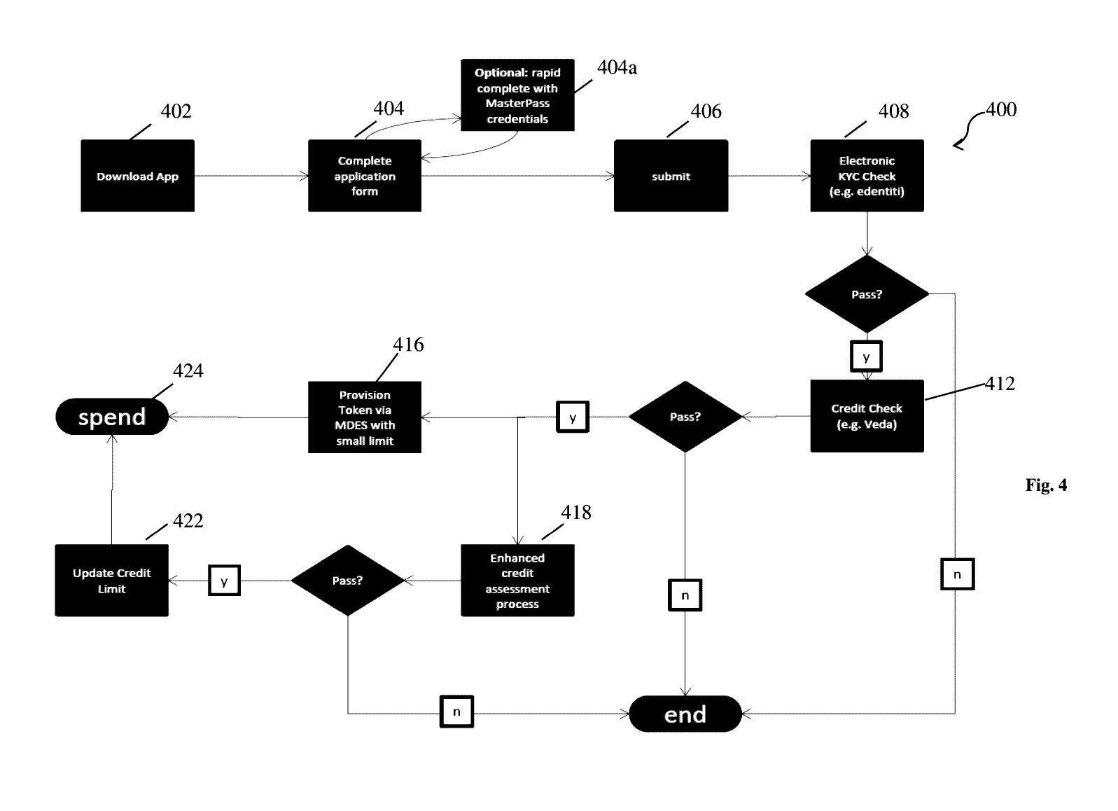

FIG. 4 illustrates a computerized method 400 according to a further embodiment. In this embodiment, an applicant downloads a software application via the internet 402 to perform the credit application. Alternatively, an existing software application such as a web-browser installed on the data input device could be used. An application request is then electronically sent to the credit application system and the applicant is prompted to fill up an electronic application form 404 containing one or more information fields required for the credit application. Optionally, the applicant may use MasterPass™ credentials to complete the application more rapidly 404a. Once the application data is electronically submitted via the data input device 406, the credit application system electronically obtains a verified identity of the applicant 408 by using an electronic verification system (also known as know-your-client (KYC) check). The electronic verification system may be provided by a third-party, such as edentiti. If the verification is successful, an electronic credit check is conducted at step 412 using the verified identity of the applicant. Similarly, the credit check system may be provided by a third-party, such as Veda. A credit limit for the applicant is then determined for the applicant using the outcome of the credit check system 416, 418. The credit limit may optionally be assessed using an enhanced credit assessment process 418 to obtain an updated credit limit 422. A payment token will be electronically transmitted to the data input device of the successful applicant for spending 424. In this embodiment, if the outcome of any of the KYC check 408, the credit check 412 and the enhanced credit assessment process 418 is unfavorable, the application process will end.

### Variants of the Embodiments

Many variations of the embodiments described can be made within the scope and spirit of the present invention. For example, the enhanced credit assessment process could be determined for applicants who requested a specific credit limit higher than the default limit. Furthermore, the electronic transmission between parties or systems may be initiated by either party or system. The obtained updated credit limit may be stored in the credit check system to update the record stored in the database. The KYC check and/or credit check may be performed using the databases of the lending institution, or third-party databases.

1. A computerized method of issuing credit to an applicant, comprising steps of:
(a) receiving a credit application request from the applicant, said credit application request being transmitted electronically via a mobile data input device of the applicant;
(b) sending an electronic query to the applicant requesting a response including application data required from the applicant;
(c) electronically receiving the application data via the data input device, said application data containing information indicative of an identity of the applicant;
(d) electronically obtaining a verified identity of the applicant using the application data;
(e) electronically determining a credit limit using the verified identity of the applicant; and
(f) electronically transmitting a payment token to the data input device of the applicant, wherein said payment token is a system of payment capable of making a payment up to the determined credit limit.

2. The computerized method of claim 1, wherein the application data comprises information required by a lending institution which issues the credit to the applicant.

3. The computerized method of claim 1, wherein the application data comprises information input by the applicant via the data input device.

4. The computerized method of claim 1, wherein the application data comprises information associated with the data input device of the applicant.

5. The computerized method of claim 4, wherein the application data comprises a unique identifier associated with the data input device.

6. The computerized method of claim 1, wherein the application data comprises credentials of the applicant for a payment system at which the applicant has previously registered.

7. The computerized method of claim 1, wherein step (d) comprises verifying the identity of the applicant using the application data and an electronic verification system containing a database storing personal particulars of the applicant.

8. The computerized method of claim 1, wherein step (e) comprises performing a credit check using the verified identity of the applicant to obtain a credit score, and determining the credit limit using the credit score.

9. The computerized method of claim 1, wherein step (e) further comprises updating the credit limit using the application data received via the data input device.

10. The computerized method of claim 1, wherein step (f) further comprises creating a link between the payment token and the data input device such that the payment token is capable of making the payment upon an authorization by the data input device.

11. A computer system having a processor and a data storage device storing program instructions, the program instructions being operative upon being performed by the processor to cause the processor to perform a method of issuing credit to an applicant comprising steps of:
(a) receiving a credit application request from the applicant, said credit application request being transmitted electronically via a mobile data input device of the applicant;
(b) sending an electronic query to the applicant requesting a response including application data required from the applicant;
(c) electronically receiving the application data via the data input device, said application data containing information indicative of an identity of the applicant;
(d) electronically obtaining a verified identity of the applicant using the application data;
(e) electronically determining a credit limit using the verified identity of the applicant; and
(f) electronically transmitting a payment token to the data input device of the applicant, wherein said payment token is a system of payment capable of making a payment up to the determined credit limit.

12. A tangible data storage device, readable by a computer system and containing program instructions operable by a processor of the computer system to cause the processor to perform a method of issuing credit to an applicant comprising steps of:
(a) receiving a credit application request from the applicant, said credit application request being transmitted electronically via a mobile data input device of the applicant;
(b) sending an electronic query to the applicant requesting a response including application data required from the applicant;
(c) electronically receiving the application data via the data input device, said application data containing information indicative of an identity of the applicant;
(d) electronically obtaining a verified identity of the applicant using the application data;
(e) electronically determining a credit limit using the verified identity of the applicant; and
(f) electronically transmitting a payment token to the data input device of the applicant, wherein said payment token is a system of payment capable of making a payment up to the determined credit limit.

13. A mobile data input device having a processor and a data storage device storing program instructions, the program instructions being operative upon being performed by the processor to cause the processor to perform a method of credit application comprising steps of:
(a) electronically transmitting a credit application request to a credit application system;
(b) receiving an electronic query requesting a response including application data required;
(c) electronically transmitting the application data to the credit application system for verification of an identity of the applicant, said application data containing information indicative of an identity of the applicant; and
(d) electronically receiving a payment token, wherein said payment token is a system of payment capable of making a payment up to a credit limit; wherein the credit limit is electronically determined using a verified identity of the applicant.
